(19) United States
(12) Patent Application Publication
(10) Pub. No.: US 2017/0139119 A1
(43) Pub. Date: May 18, 2017

(54) DOUBLE-SIDED ADHESIVE FOR LIQUID CRYSTAL DISPLAY MODULE AND NARROW BEZEL LIQUID CRYSTAL DISPLAY MODULE

(71) Applicant: Wuhan China Star Optoelectronics Technology Co., Ltd., Wuhan, Hubei (CN)

(72) Inventor: Yanxue ZHANG, Wuhan, Hubei (CN)

(21) Appl. No.: 14/764,290

(22) PCT Filed: May 22, 2015
(86) PCT No.: PCT/CN2015/079622

§ 371 Date: Jul. 29, 2015

(30) Foreign Application Priority Data
Apr. 29, 2015 (CN) 201510219537.1

(51) Int. Cl. F21V 8/00; G02F 1/1333; G02F 1/1335

(52) U.S. Cl. CPC G02B 6/0088; G02B 6/0055; G02F 1/133512; G02F 1/133308; G02F 2001/133314; G02F 2202/28

(57) ABSTRACT

A narrow bezel liquid crystal display module including a backlight module and a liquid crystal panel disposed opposite to each other. The backlight module and the liquid crystal panel adhering to each other via a double-sided adhesive. The backlight module including a back frame and an optical assembly disposed in the back frame, wherein at least a part of the double-sided adhesive adopts a first type of double-sided adhesives, the first type of double-sided adhesives includes a light shielding part and a light transmission part extending along its length direction, the light shielding part adheres to a side wall of the back frame, and the light transmission part adheres to the optical assembly. The light transmission part of the double-sided adhesive may have a greater width to extend to the optical assembly, thereby increasing a width of the double-sided adhesive overall.

### TECHNICAL FIELD

The present application relates to Liquid Crystal Display technical field, and more particularly relates to a double-sided adhesive for a liquid crystal display module and a narrow bezel liquid crystal display module.

### BACKGROUND ART

Information is gradually spread to people with rapid development of network and wireless communication technology. Thus, portable information products, such as notebook computers, mobile phones, digital cameras and Personal Digital Assistants (PDA) etc., are rapidly developed and growing. Since a Liquid Crystal Display (LCD) has advantages of thinness, lightweight, low power consumption, non-radiation pollution and being compatible with semiconductor process, application of LCD products produces a leap growth complying with the rise of a network digital information market. In an increasing competitive display market, differentiated design becomes one of the most important research directions for respective manufacturer to improve its own product selling point. In the current products, a thin or narrow bezel design is common, which may obtain the more beautiful appearance to attract attention of consumers.

A current LCD module as shown in FIG. 1 includes a backlight module 1 and a liquid crystal panel 2 disposed opposite to each other, wherein the backlight module 1 provides display light source to the liquid crystal panel 2 so that the liquid crystal panel 2 displays images. The backlight module 1 includes a back frame 3 and an optical assembly 4 disposed in the back frame 3, and a rubber frame 6 is disposed between a side wall 5 of the back frame 3 and the optical assembly 4. A double-sided adhesive 7 extending to the optical assembly 4 adheres to the side wall 5 of the back frame 3, and the liquid crystal panel 2 adheres to the backlight module 1 via the double-sided adhesive 7.

The double-sided adhesive 7 not only functions to paste the liquid crystal panel 2 and the backlight module 1, but also functions to prevent light leak. Thus, a color of the double-side adhesive 7 is generally black. At present, in order to achieve a narrow bezel, it needs to thin the side wall 5 of the back frame 3, even if to remove the rubber frame 6 between the side wall 5 and the optical assembly 4, and at this moment, a width of the double-sided adhesive 7 on the side wall 5 will be correspondingly reduced; since the double-sided adhesive 7 is black and cannot extend to the optical assembly 4 too much, the width of the black double-sided adhesive 7 will become very small to meet requirements of a narrow bezel.

When the width of the double-sided adhesive 7 becomes very small, it will cause the following problems: 1. if the width of the adhesive tap is too small, it is not easy to cut; 2. if the width of the adhesive tap is too small, warpage or displacement easily occur after the adhesion is completed; and 3. if the width of the adhesive tap is too small, adhesive force between the liquid crystal panel 2 and the backlight module 1 is not sufficient.

### SUMMARY

Due to the disadvantages of the prior art, the present application provides a narrow bezel LCD module, which not only enables a LCD module to meet requirements of a narrow bezel but also resolves the problems existing in the prior art by improving a structure of a double-sided adhesive pasting a liquid crystal panel and a backlight module.

In order to achieve the above purpose, the present application adopts the following technical solution:

a narrow bezel LCD module includes a backlight module and a liquid crystal panel disposed opposite to each other, the backlight module and the liquid crystal panel adhering to each other via a double-sided adhesive; the backlight module includes a back frame and an optical assembly disposed in the back frame, wherein at least a part of the double-sided adhesive adopts a first type of double-sided adhesives, the first type of double-sided adhesives includes a light shielding part and a light transmission part extending along its length direction, the light shielding part adheres to a side wall of the back frame, and the light transmission part adheres to the optical assembly;

wherein a width of the light transmission part is greater than a width of the light shielding part;

wherein the first type of double-sided adhesives is manufactured by a light transmission material, and the light shielding part thereof is manufactured by painting a black material;

wherein the optical assembly includes a reflector, a light guide plate and an optical film set which are sequentially stacked up on a bottom plate of the back frame, and the light transmission part adheres to the optical film set;

wherein the optical assembly further includes a light source between the side wall of the back frame and the light guide plate; wherein the double-sided adhesive adhering to an upper portion of the side of the backlight module on which the light source is disposed adopts a second type of double-sided adhesives, the second type of double-sided adhesives is a shading double-sided adhesive, and the double-sided adhesives adhering to the rest part of the backlight module adopts the first type of double-sided adhesives;

wherein the light source is a LED lamp.

Another aspect of the present application provides a double-sided adhesive for a LCD module, which is used to paste a liquid crystal panel in the LCD module to a backlight module; the backlight module includes a back frame and an optical assembly disposed in the back frame, wherein the double-sided adhesive includes a light shielding part and a light transmission part extending along its length direction, the light shielding part adheres to a side wall of the back frame, and the light transmission part adheres to the optical assembly;

wherein a width of the light transmission part is greater than a width of the light shielding part;

wherein the light transmission part of the double-sided adhesive is manufactured by a light transmission material, and the light shielding part thereof is manufactured by painting a black material.

By comparing with the prior art, in the narrow bezel LCD module provided by the embodiments of the present application, regarding the double-sided adhesive for pasting the liquid crystal panel and the backlight module, a portion at a narrow bezel adopts a double-sided adhesive including a light shielding part and a light transmission part; the light shielding part adheres to the side wall of the back frame to avoid light leak; the light transmission part adheres to the optical assembly; since the light transmission part does not affect the light emitted from the backlight module reaching the liquid crystal panel, the light transmission part may have a greater width to extend to the optical assembly, thereby increasing the width of the double-sided adhesive overall; due to the increase of the width of the double-sided adhesive, the adhesive tape is easily cut, warpage and displacement do not easily occur after the adhesion is completed, and sufficient adhesive force is provided between the liquid crystal panel and the backlight module.

### BRIEF DESCRIPTION OF THE DRAWINGS

FIG. 1 is a structure diagram of a current liquid crystal display module.

FIG. 2 is a structure diagram of a narrow bezel liquid crystal display module according to an embodiment of the present application.

FIG. 3 is a top-down diagram of a backlight module after a double-sided adhesive is pasted according to an embodiment of the present application.

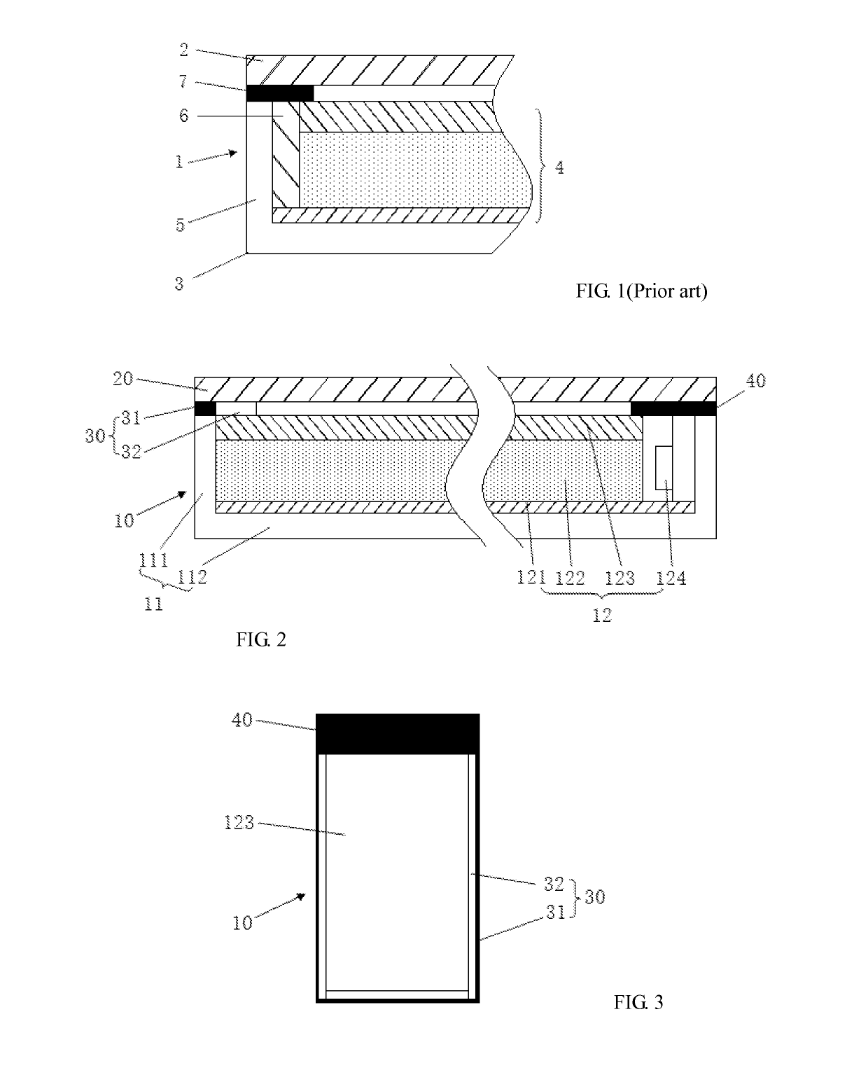

### DETAILED DESCRIPTION OF EXEMPLARY EMBODIMENTS

Below the technical solutions of the embodiments of the present application are described in detail in conjunction with the accompanying drawings and the exemplary embodiments. Obviously, the described embodiments are only a part of the examples of the present application rather than all the exemplary embodiments. Based on the embodiments of the present application, all the other embodiments acquired by those ordinarily skilled in the art without exerting any creative effort fall within a protection scope of the present application.

By referring to FIGS. 2 and 3, a narrow bezel LCD module according to the present embodiment includes a backlight module 10 and a liquid crystal panel 20 disposed opposite to each other and adhering to each other via a double-sided adhesive.

The backlight module 10 includes a back frame 11 and an optical assembly 12 disposed in the back frame 11. The back frame 11 includes a side wall 111 and a bottom plate 112. The optical assembly 12 at least includes a reflector 121, a light guide plate 122 and an optical film set 123 which are sequentially stacked up on the bottom plate 112 of the back frame 11, and the optical assembly 12 further includes a light source 124 between the side wall 111 of the back frame 11 and the light guide plate 122. The light source 124 adopts a LED lamp.

The double-sided adhesive for adhesively connecting the backlight module 10 and the liquid crystal panel 20 includes a first type of double-sided adhesives 30 and a second type of double-sided adhesives 40. Regarding a margin of the whole backlight module 10, the double-sided adhesive adhering to an upper portion of the side on which the light source 124 is disposed adopts the second type of double-sided adhesives 40, and the second type of double-sided adhesives 40 is a shading double-sided adhesive; one end of the second type of double-sided adhesives 40 adheres to the side wall 111 of the back frame 11, and the other end thereof across the light source 124 extends to be adhesive to the optical film set 123, wherein a width of a portion of the double-sided adhesive adhering to the optical film set 123 is relatively small. The double-sided adhesive adhering to the remaining margin of the backlight module 10 adopts the first type of double-sided adhesives 30; the first type of double-sided adhesives 30 includes a light shielding part 31 and a light transmission part 32 extending along its length direction; the light shielding part 31 adheres to the side wall 111 of the back frame 11; the light transmission part 32 adheres to the optical film set 123; and a width of the light transmission part 32 adhering to the optical film set 123 is greater than that of the light shielding part 31.

Furthermore, the light transmission part 32 of the first type of double-sided adhesives 30 is manufactured by a light transmission material, and the light shielding part 31 thereof is manufactured by painting a black material.

In the narrow bezel LCD module provided by the above embodiment, regarding the double-sided adhesive for pasting the liquid crystal panel and the backlight module, a portion at a narrow bezel (except a side of the bezel where the light source is disposed) adopts a double-sided adhesive including a light shielding part and a light transmission part; the light shielding part adheres to the side wall of the back frame to avoid light leak; the light transmission part adheres to the optical assembly; since the light transmission part does not affect the light emitted from the backlight module reaching the liquid crystal panel, the light transmission part may have a greater width to extend to the optical assembly, thereby increasing the width of the double-sided adhesive overall; due to the increase of the width of the double-sided adhesive, the adhesive tape is easily cut, warpage and displacement do not easily occur after the adhesion is completed, and sufficient adhesive force is provided between the liquid crystal panel and the backlight module.

It should be explained that the relationship terms, such as first and second, etc., in the present text are only used for distinguishing one entity or operation from another entity or operation without requiring or implying any actual relation or sequence existing between these entities or operations. Moreover, the term “include”, “contain” or any other variant means covering instead of exclusively including, so that the process, method, object or device including a series of factors not only includes those factors but also includes other factors that are not explicitly listed or further includes inherent factors for this process, method, object or device. Where no more limitations are provided, the factors defined by the sentence “include one . . . ” do not exclude additional identical factors existing in the process, method, object or device which includes the factors.

The above statements are only the specific embodiments of the present application, it should be pointed out that, to those ordinarily skilled in the art, several improvements and polish can be made without breaking away from the principle of the present application, also those improvements and polish should be considered as the protection scope of the present application.

1. A narrow bezel liquid crystal display module, comprising a backlight module and a liquid crystal panel disposed opposite to each other, the backlight module and the liquid crystal panel adhering to each other via a double-sided adhesive, the backlight module comprising a back frame and an optical assembly disposed in the back frame, wherein at least a part of the double-sided adhesive adopts a first type of double-sided adhesives, the first type of double-sided adhesives comprises a light shielding part and a light transmission part extending along its length direction, the light shielding part adheres to a side wall of the back frame, and the light transmission part adheres to the optical assembly.

2. The narrow bezel liquid crystal display module of claim 1, wherein the light transmission part of the first type of double-sided adhesives is manufactured by a light transmission material, and the light shielding part thereof is manufactured by painting a black material.

3. The narrow bezel liquid crystal display module of claim 2, wherein the optical assembly further comprises a light source between the side wall of the back frame and a light guide plate, wherein the double-sided adhesive adhering to an upper portion of the side of the backlight module on which the light source is disposed adopts a second type of double-sided adhesives, the second type of double-sided adhesives is a shading double-sided adhesive, and the double-sided adhesive adhering to the rest part of the backlight module adopts the first type of double-sided adhesives.

4. The narrow bezel liquid crystal display module of claim 3, wherein the light source is a LED lamp.

5. The narrow bezel liquid crystal display module of claim 1, wherein a width of the light transmission part is greater than a width of the light shielding part.

6. The narrow bezel liquid crystal display module of claim 5, wherein the light transmission part of the first type of double-sided adhesives is manufactured by a light transmission material, and the light shielding part thereof is manufactured by painting a black material.

7. The narrow bezel liquid crystal display module of claim 6, wherein the optical assembly further comprises a light source between the side wall of the back frame and a light guide plate, wherein the double-sided adhesive adhering to an upper portion of the side of the backlight module on which the light source is disposed adopts a second type of double-sided adhesives, the second type of double-sided adhesives is a shading double-sided adhesive, and the double-sided adhesive adhering to the rest part of the backlight module adopts the first type of double-sided adhesives.

8. The narrow bezel liquid crystal display module of claim 7, wherein the light source is a LED lamp.

9. The narrow bezel liquid crystal display module of claim 1, wherein the optical assembly comprises a reflector, a light guide plate and an optical film set which are sequentially stacked up on a bottom plate of the back frame, wherein the light transmission part adheres to the optical film set.

10. A double-sided adhesive for a liquid crystal display module, the double-sided adhesive is used for pasting a liquid crystal panel in the liquid crystal display module to a backlight module, the backlight module comprises a back frame and an optical assembly disposed in the back frame, wherein the double-sided adhesive comprises a light shielding part and a light transmission part extending along its length direction, the light shielding part adheres to a side wall of the back frame, and the light transmission part adheres to the optical assembly.

11. The double-sided adhesive for a liquid crystal display module of claim 10, wherein a width of the light transmission part is greater than a width of the light shielding part.

12. The double-sided adhesive for a liquid crystal display module of claim 11, wherein the light transmission part of the double-sided adhesive is manufactured by a light transmission material, and the light shielding part thereof is manufactured by painting a black material.
